(19) United States
(12) Patent Application Publication
(10) Pub. No.: US 2007/0271532 A1
(43) Pub. Date: Nov. 22, 2007

(54) Method and apparatus for displaying layered user interface

(76) Inventors: Loc V. Nguyen, Everett, WA (US); Edward C. Drake, Bothell, WA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/517,968

(22) Filed: Sep. 8, 2006

Related U.S. Application Data
(60) Provisional application No. 60/801,712, filed on May 19, 2006.

(51) Int. Cl. G06F 3/00

(52) U.S. Cl. 715/854

(57) ABSTRACT

A method including displaying an initial navigation layer in a fixed focus area on a screen, the initial navigation layer including a plurality of graphical navigation icon blocks; displaying a stacked graphical navigation icon block representative of the initial layer and graphical navigation icon blocks representative of subsequent navigation layers as a visible stack in a fixed focus area on the screen after a graphical navigation icon block from the initial layer has been selected such that a followed path is visible.

### BACKGROUND OF THE INVENTION

1. Field of the Invention

This invention relates to user interfaces and interactive television and video systems. More particularly, the invention relates to methods for presenting a layered user interface through a graphic display. The invention also encompasses an apparatus and program product for implementing the presentation method.

2. Description of the Related Art

User interfaces for applications such as interactive television are often based on moving a focus area on a screen around fixed text elements. For example, a user can employ a remote control to move a focus area to highlight different texts on the screen. The user can select the highlighted text and then move on to a next screen.

This is illustrated by way of example in FIG. 1. Shown at 100 is a video control system including a television 104 and a remote control 106. The television 102 displays a user interface 102 that is manipulatable by a user using remote control 106. (Typically, the programming for controlling the user interface is provided by a set top box or other controller (not shown)).

In the example illustrated, text elements 108a define user selection choices. A user can use the remote control 106 to scroll a focus area 110 up or down the selections and can then choose the appropriate desired selection. If the user does so, he may be navigated to a subsequent screen, for example, a listing of sub-elements 108b of the selected element. Again, the user can scroll a focus area 114 to highlight and select the desired choice.

Such interfaces as shown in FIG. 1 fail to provide a compelling user experience and also fail to allow the user to see where he has navigated from. In addition, such user interfaces can make the navigation back to an original screen relatively difficult.

### SUMMARY OF THE INVENTION

A method embodying principles of the invention includes displaying an initial navigation layer in a fixed focus area on a screen, the initial navigation layer including a plurality of graphical navigation icon blocks; displaying a stacked graphical navigation icon block representative of the initial layer and graphical navigation icon blocks representative of subsequent navigation layers as a visible stack in a fixed focus area on the screen after a graphical navigation icon block from the initial layer has been selected such that a followed path is visible.

A method according to embodiments of the present invention includes displaying an initial navigation layer of graphical navigation icon blocks in a fixed focus area on a screen; displaying a first subsequent navigation layer after a navigation icon from the initial layer has been selected; and displaying the initial navigation layer as a stack in said first subsequent navigation layer while said first subsequent navigation layer is displayed.

An apparatus according to embodiments of the present invention includes a display device; an input device; and a processor configured to cause the display device to display an initial navigation layer in a fixed focus area on a screen, the initial navigation layer including a plurality of graphical navigation icon blocks; and display a stacked graphical navigation icon block representative of the initial layer and graphical navigation icon blocks representative of subsequent navigation layers as a visible stack in a fixed focus area on the screen after a graphical navigation icon block from the initial layer has been selected such that a followed path is visible

A program product stored on one or more computer readable devices includes code executable to cause a display device to display an initial navigation layer in a fixed focus area on a screen, the initial navigation layer including a plurality of graphical navigation icon blocks; and code executable to cause a display device to display a stacked graphical navigation icon block representative of the initial layer and graphical navigation icon blocks representative of subsequent navigation layers as a visible stack in a fixed focus area on the screen after a graphical navigation icon block from the initial layer has been selected such that a followed path is visible.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates operation of a graphical user interface according to the prior art.

FIG. 2A-FIG. 2C schematically illustrate operation of an embodiment of the present invention.

FIG. 3A-FIG. 3D illustrate operation of an embodiment of the present invention.

FIG. 4 is a flowchart illustrating operation of an embodiment of the present invention.

FIG. 5A-FIG. 5B illustrate an exemplary media distribution system that may be used in with a layered user interface system according to embodiments of the present invention.

FIG. 6A-FIG. 6B is a diagrammatic representation of a user station and system that may be used to implement methods according to embodiments of the present invention.

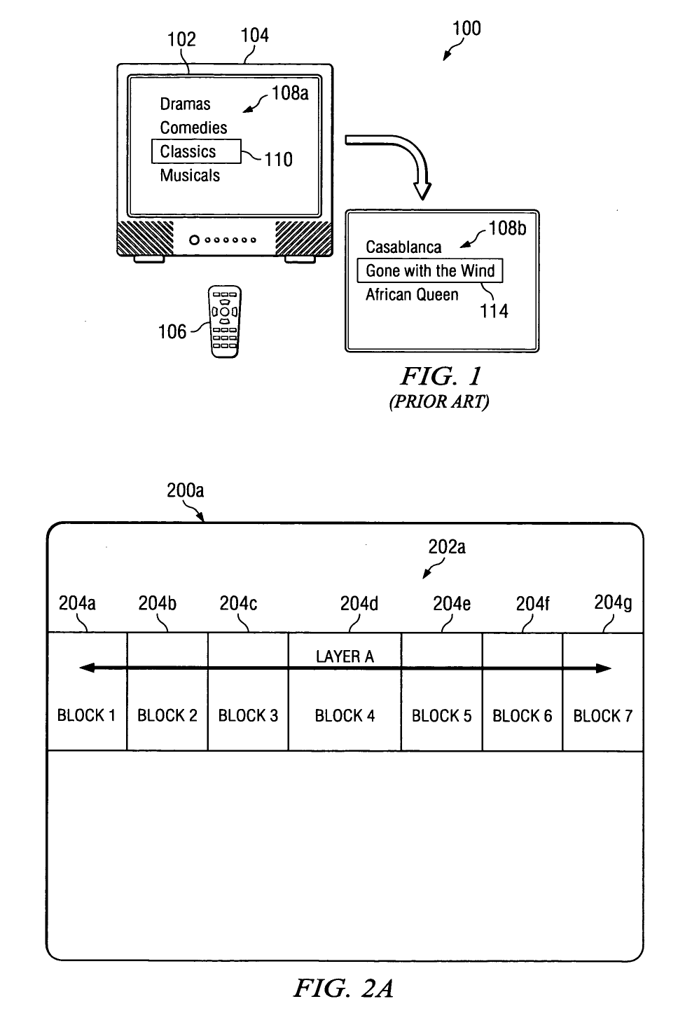

### DETAILED DESCRIPTION OF EMBODIMENTS OF THE INVENTION

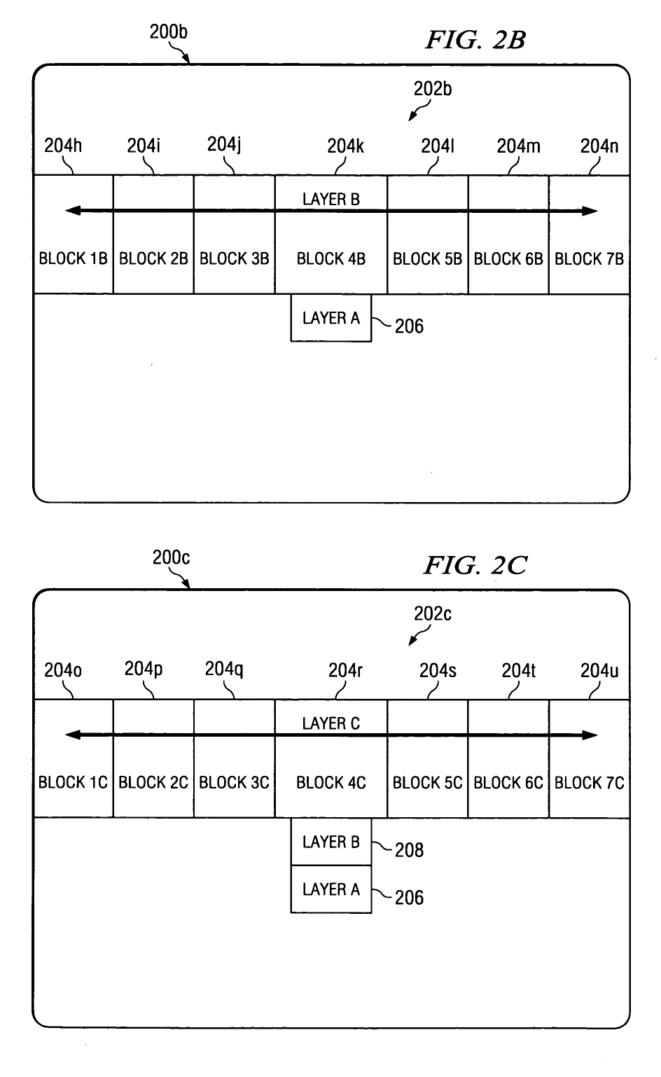

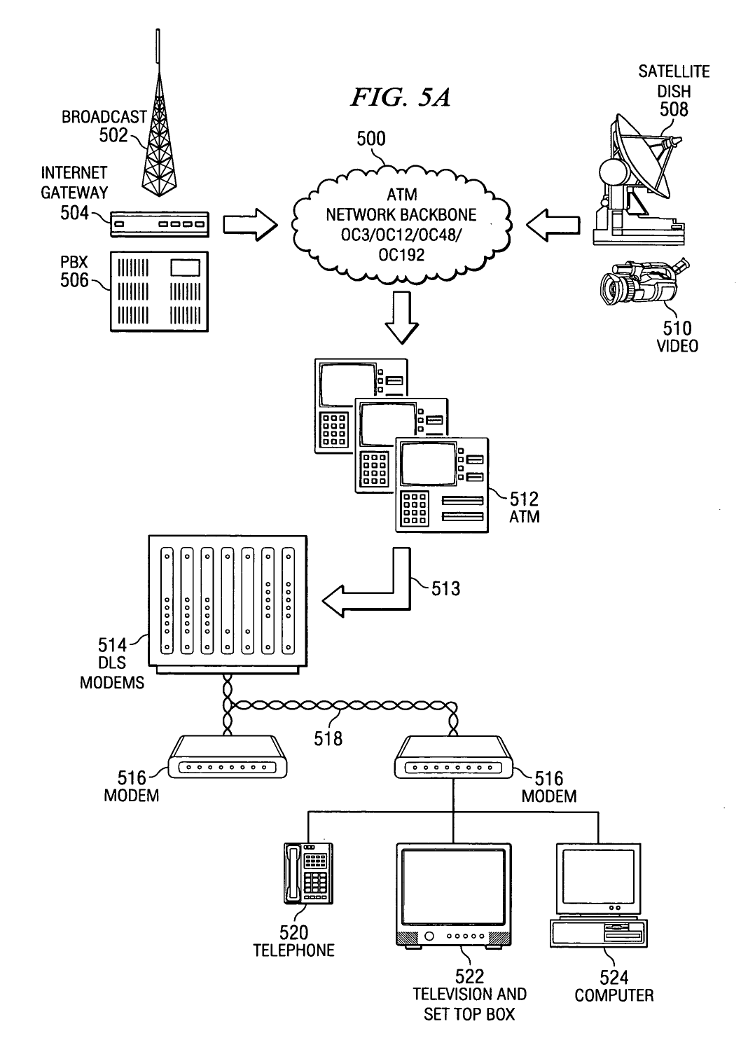

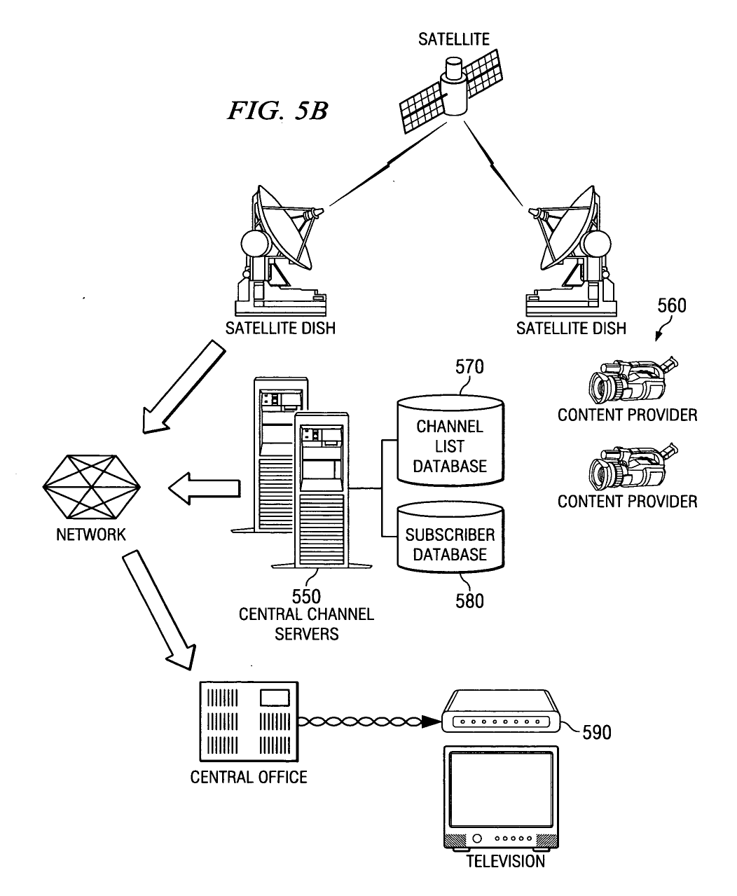

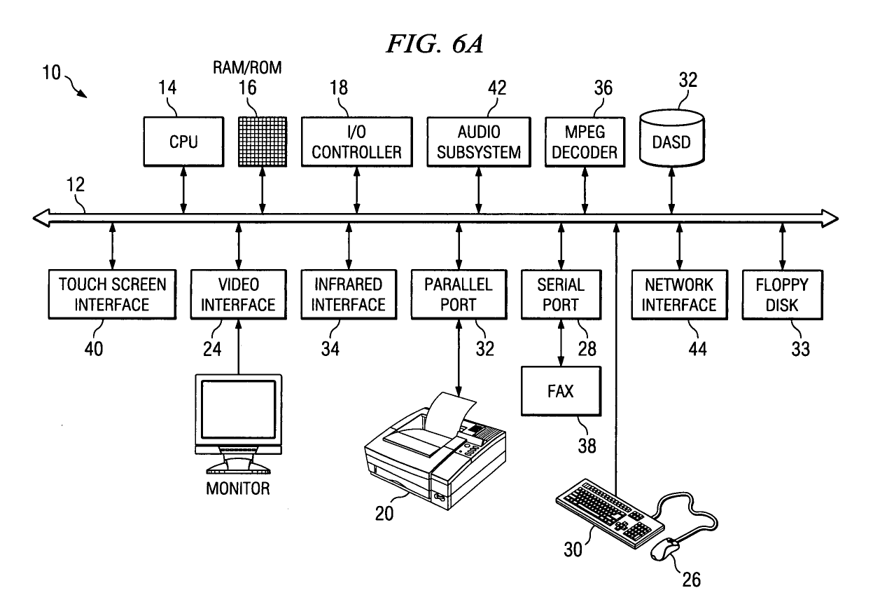

A representation of a graphic display 200a that may be produced in a method embodying the principles of the invention is shown in FIG. 2A. The display shown in FIG. 2A may be produced on a video display device associated with a user station that implements the invention. Example user stations and other components of a system implementing the present invention will be discussed below with reference to FIG. 5 and FIG. 6. According to one preferred embodiment, the graphic display is used in association with an Internet protocol media distribution system.

The exemplary display 200 shown in FIG. 2A includes a navigation layer A 202a including one or more graphical navigation icon blocks 204a-204g. In the example illustrated, seven graphical navigation icon blocks 204a-204g are shown. In other embodiments, however, the number may be greater or fewer. Also, while illustrated as a single horizontal layer, in other embodiments, the navigation layer may be presented as a vertical layer.

In some embodiments, the focus area remains fixed while the user can move the graphic navigation icon blocks into and out of the focus area. For example, the focus area could be the area centered in the screen; when an icon is in the focus area, some indicia or highlighting may be provided. In the example illustrated, block 204d is in the focus area. In some embodiments, a user can “navigate” or move left or right to reveal “hidden” navigation icon blocks (not shown) to the left and right of the screen. Thus, the number of navigation icon blocks in a given navigation layer may be more than are visible at a given time. In some embodiments, the row of navigation icon blocks can “loop,” i.e., continued navigation left or right from one navigation icon block will eventually cause a cycling through all icon blocks in the layer and back to the original.

In operation, a user can “select” one of the graphic navigation icon blocks 204a-204g when in the focus area to navigate to a subsequent layer in the interface. For example, turning now to FIG. 2B, a display 200b of a subsequent navigation layer B 202b is shown. In particular, shown is a navigation layer 202b including one or more navigation blocks 204h-304n.

Also shown is a navigation icon 206 representative of layer A, i.e., the previous layer, which has “dropped down” and anchored to the current layer. The navigation icon A 206 allows the user to easily see and grasp the path he has followed. In some embodiments, selection of the icon 104 allows the user to go back to the previous layer. According to some embodiments, the navigation icon A 206 is “fixed” to the layer currently being shown. That is, while graphic navigation icon blocks 204h-204n can shift within the current navigation layer, the navigation icon A 206 remains fixed to it. In some embodiments, the navigation icon A and stack may be fixed to the focus area of the layer above.

In operation, again depending on the embodiment, a user can move the graphic navigation icon blocks left or right, depending on the number of graphical navigation icon blocks 204h-204n in layer 202b. Also, depending on the embodiment, he can select one of the graphical navigation icon blocks 204h-204n for navigation to a next layer or destination.

Such a layer 202c is shown in the display 200c of FIG. 2C. Shown in layer C 202c are a plurality of navigation icon blocks 204o-204u. Icon 206, representing layer 202a, has dropped down and icon 208, representing layer 202b, has been inserted in the stack. In operation, again depending on the embodiment, a user can move left or right, depending on the number of graphical navigation icon blocks 204o-204u in layer 202c. Also, depending on the embodiment, he can select one of the graphical navigation icon blocks 204o-204u for navigation to a next layer or destination. It is noted that each layer 202a, 202b, 202c may, in practice, each include different numbers of graphic navigation icon blocks. Thus, the figures are exemplary only.

The stacked layers 206, 208 provide the user a visual representation of where he has been and allow the user to navigate back to a previous layer. Again, the stacked layers are typically fixed in relationship to the layer being presently viewed.

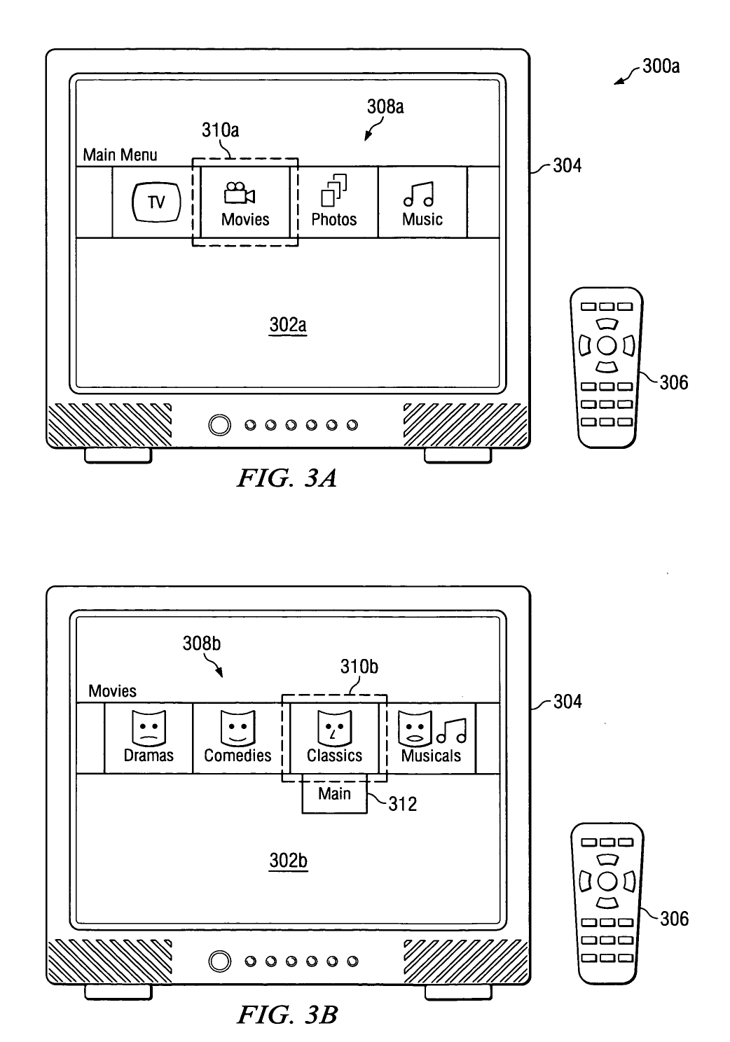

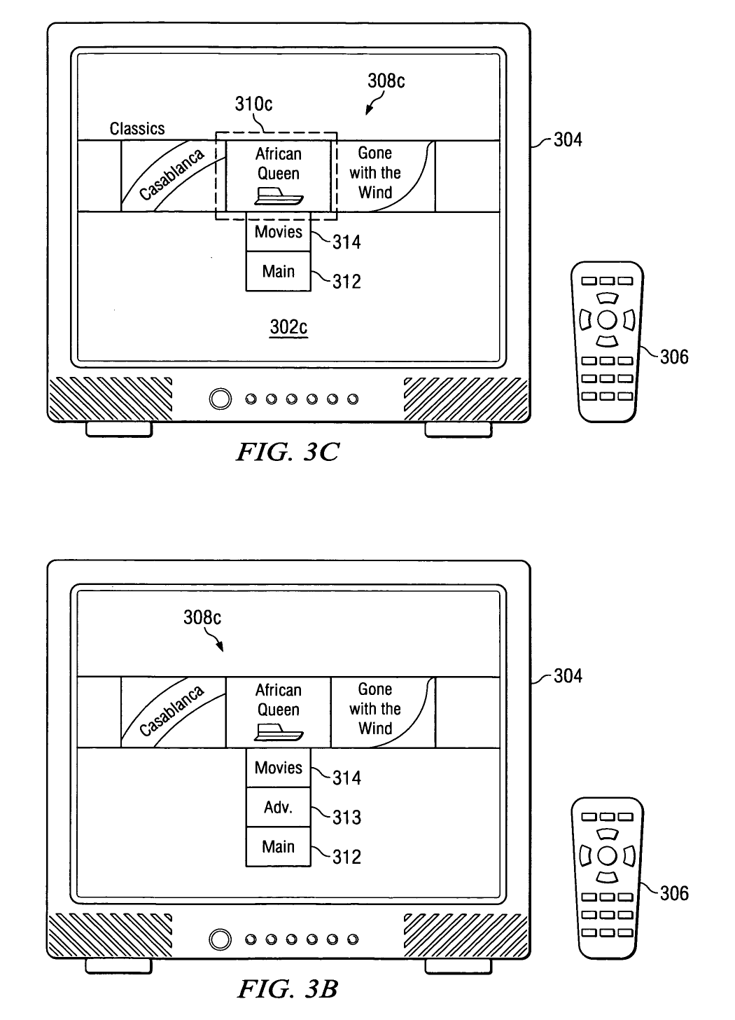

Turning now to FIG. 3A-FIG. 3D, diagrams illustrating exemplary graphical user interfaces according to specific embodiments of the present invention are shown by way of example. In particular, the embodiments illustrated in FIG. 3A-FIG. 3D show specific user interfaces for use with, for example, an exemplary system for delivering voice, video, data, and interactive services over the twisted copper network, as discussed greater detail below with reference to FIGS. 5A, 5B, 6A, and 6B.

Shown in FIG. 3A is a system 300a including a user interface 302a in a video display 304 and a remote control 306. The video display 304 may be embodied as, for example, a television set including set top box (not shown) functionality for providing, e.g., voice, video, data, and interactive services.

Shown in user interface 302a is a navigation layer (labeled Main menu) 308a including a plurality of graphic navigation icon blocks. In the example illustrated, the menu items represent TV, Movie, Photos, and Music selections. It is noted that, in other embodiments, different selections may be available.

In operation, a user can manipulate the remote control 306 to control the movement of the graphic navigation icon blocks and highlight a selected one of the graphic navigation icon blocks by moving it within a fixed focus area 310a. As shown in FIG. 3A, the user has selected the Movies graphic navigation icon block.

The resulting display is shown in FIG. 3B. More particularly, a navigation layer 308b labeled “Movies” is shown. In the example illustrated, the Movies include categories Dramas, Comedies, Classics, and Musicals, represented as graphical navigation icon blocks. Also shown is a stacked icon 312 representing the layer navigated from, i.e., the Main Menu layer.

In operation, the user can use the remote control 306 to navigate the layer 308b or select the previous layer 312. If he selects the previous layer 312, he will navigate back to the screen shown in FIG. 3A. Otherwise, if he, for example, selects the Classics graphic navigation icon block at 310b, then he will navigate to the one shown in FIG. 3C.

Shown in FIG. 3C is a navigation layer 308c labeled “Classics.” The navigation layer 308c includes a plurality of graphic navigation icon blocks; this time, blocks labeled Casablanca, Gone with the Wind, and African Queen, are shown. Also shown is a stack having navigation icons 312, 314 representing the Main Menu and the Movies menu. Again, the user can navigate back to the previous menus using the appropriate navigation icon. Alternatively, in the example shown, he can move an icon into the focus area and can select a movie to view it, as shown at 310c.

Once the movie has finished, or the user otherwise interrupts it, he can be navigated back to the display of FIG. 3C. Again, this can allow the user to see the path he has taken and more effectively navigate the system. Alternatively, he may be navigated back to the main menu of FIG. 3A.

It is noted that, while the “stack” of navigation layers 312, 314 is illustrated as a hierarchical format, in practice, the system may be configured to insert other, non-hierarchically-related icons into the stack. These may include, for example, advertisements, help icons, and the like. For example, shown in FIG. 3D is a screen generally similar to that of FIG. 3C. However, one of the stack elements is an advertisement icon 313 between icons 312 and 314. If the user selects the icon 314, a corresponding advertisement may be displayed or shown.

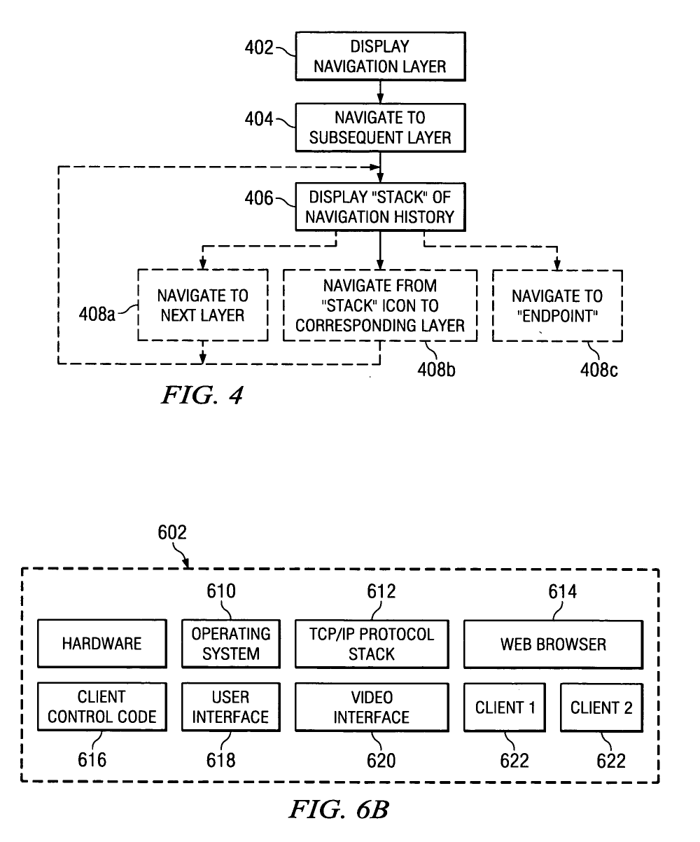

Turning now to FIG. 4, a flowchart 400 illustrating operation of embodiment of the present invention is shown. The particular arrangement of elements in the flowchart 400 is not meant to imply a fixed order to the elements; embodiments can be practiced in any order that is practicable.

As indicated at process block 402, the invention includes displaying a screen including a navigation layer such as the navigation layer 302a shown in FIG. 3A. This step of displaying the navigation layer 302a may be performed under the control of any suitable graphics control device and/or under the control of a suitable general purpose processor executing operational program code.

As indicated at process block 404, the system can navigate to a subsequent layer, typically responsive to input from the user. For example, the player can select a navigation icon block by navigating it into the focus area using the remote control 306, or provide other user input.

As indicated at process block 406, the system can generate or display a block fixed to the new displayed layer as a stack or a part of a stack representing the previous layer.

As indicated in process block 408a, the user can then select one of the navigation icon blocks in the displayed navigation layer to navigate to a next or subsequent navigation layer. If so, then the system will display an updated stack of navigation history. Thus, the system will store in memory, at least temporarily, a history of the user's activities.

Alternatively, as shown in process block 408b, the user could select the stack icon and navigate back to the (or one of the) previous navigation layers. Finally, as indicated at process block 408c, the user could select one of the graphic navigation icon blocks from the current navigation layer, and thereby navigate to the menu endpoint or desired final destination.

As discussed above, embodiments of the present invention are suited to an internet protocol media distribution system. FIG. 5A depicts a representative environment according to the invention. Central to FIG. 5A is a network with ATM network backbone 500. This ATM network is capable of fiber data rates of OC3, OC12, OC48, OC192 or as is available in the art. A plurality of content providers place information onto ATM network 500. Typical sources of content served include broadcast information 502, Internet information 504, telenetwork 506, broadcast content 508, and video 510.

In a representative central plant, a plurality of ATM switches 512 interface with network 500 to receive and distribute data from the various content sources. Information flows from ATM switches 512 via a plurality of paths 513 to a plurality of DSL modems 514. DSL modems 514 connect via DSL twisted pair lines 518 to a plurality of modems 516 in various subscribers residences or establishments. From a representative modem 516, there can be attached a telephone 520 and/or a television set which may include and associated set top box 522, and/or a computer 524. The graphical user interface of embodiments of the present invention may thus be operable on or in association with devices such as telephone 520, television with set top box 522, and/or computer 524.

FIG. 5B depicts an overview of a digital programming content distribution system according to a particular embodiment of the present invention. One or more central channel server(s) 550 collect(s) information about available programming services distributed from a multiplicity of content providers 560. In a preferable embodiment, this information is multicast by the content providers using the session announcement protocol. Channel server 550 maintains a channel list database 570 which tracks available content channel offerings and a subscriber database 580, which contains subscriber identifications and permitted channels for each subscriber. Subscribers 590 interact with central channel server 550 to obtain programming content information, and with content providers 160 to obtain programs. In related embodiments, the channel server 550 and content providers 560 may be co-located on the same machine, or may reside on separate machines. In related embodiments, subscriber database 580 and channel list database 570 may be co-located on the same machine, or may reside on separate machines. Thus, the figure is exemplary only.

In a representative embodiment, the invention may be practiced using a set top box or control system with the basic subsystems and functions depicted in FIG. 6A. In the representative system of FIG. 6A, a set top or control unit 10 includes bus 12, which is shown schematically as a single bus, but can also be a number of buses such as a local bus and one or more expansion buses (e.g., ADB, SCSI, ISA, EISA, MCA, NuBus, or PCI), which interconnect subsystems such as a central processor 14, which may be an 80x86, 68xxx, RISC, Pentium family, or other suitable microprocessor family, system memory 16, which may be RAM, ROM, or a combination thereof, input/output (I/O) controller 18, an external device such as a serial port 28, such as a USB port, and parallel port 32, detachable keyboard 30, mouse 26, fixed disk drive 32, which may be a hard disk drive or an optical drive or a CD-ROM or DVD-ROM drive or other suitable medium; and a floppy disk drive 33 operative to receive a floppy disk.

Network connections are usually established through a device such as a network adapter 44 attached to one of the buses or a modem on a serial port. Network adapters may include 10 Base T, 100 Base T, optical, ATM, DSL, or other network formats.

MPEG decoder 36 and Audio subsystem 42 coupled via bus 12 provide multimedia capability. Many other devices can be connected such as fax 38 connected via serial port 28, touch screen 40 connected directly, infrared peripheral support 34 or printer 20, connected through parallel port 22. Other devices or subsystems (not shown) may be connected in a similar manner. Also, it is not necessary for all of the devices shown in FIG. 6A to be present to practice the invention. The devices and subsystems may be interconnected in different ways from that shown in FIG. 6A without impairing the operation of the system. Source code to implement processing functions in accordance with the present invention may be operably disposed in system memory 16 or stored on storage media such as fixed disk 32 or floppy disk 33.

Video interface 33 may be any standard video format, such as S-video. Various forms of user input devices may be used. For example, a touch screen allows a user to point to objects on the screen to select the object and to move the selected object by pointing to a second position on the screen. Alternatively, an infrared or other coupled handheld control unit may be interfaced, allowing the user to interact with the unit, make changes, and indicate preferences. Various buttons and controls may be displayed on the screen for activation by using the mouse, touch screen, or a remote control via infrared IF 34.

Operatively disposed in memory 16, or resident on fixed disk 32, operating system software may be PSOS, DOS, UNIX, WINDOWS95, WINDOWS CE, WINDOWS XP, or other operating systems known in the art. Executing concurrently and cooperatively with operating system software 610 (FIG. 6B), IP Multicast capable TCP/IP software 612 manages the flow of information into and out of the set top unit over the network interface 44. A JAVA enabled Internet browser 614, such as Netscape Navigator Microsoft Explorer or their equivalent in the art provide a web-browser user interface to networked resources through TCP/IP software 612. Client control code 616 implements functions specific to the set top box operation, such as the processes depicted herein. Output to the users set is provided by user interface 618 in conjunction with Video Interface Code 620. Other clients 622 such as Email, facsimile, video conferencing applications or voice mail may also be supported. In a related embodiment, the functions of the set top unit are integrated into a television, forming an Internet capable, interactive “Smart Television.” In a related embodiment, the functions of the set top unit are integrated into a personal computer, forming an Internet-capable, interactive “Workstation Television.”

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures (Eighth Edition, August 2001 as revised October 2005), Section 2111.03.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

What is claimed is:

1. A method, comprising:
displaying an initial navigation layer in a fixed focus area on a screen, the initial navigation layer including a plurality of graphical navigation icon blocks;
displaying a stacked graphical navigation icon block representative of the initial layer and graphical navigation icon blocks representative of subsequent navigation layers as a visible stack in a fixed focus area on the screen after a graphical navigation icon block from the initial layer has been selected such that a followed path is visible.

2. A method in accordance with claim 1, wherein navigation layers are accessible through selection of a corresponding stacked graphical navigation icon block.

3. A method in accordance with claim 2, wherein navigation layers represented as stacked graphical navigation icon blocks in the visible stack are hierarchically related.

4. A method in accordance with claim 2, wherein navigation layers represented as stacked graphical navigation icon blocks in the visible stack are hierarchically independent.

5. A method in accordance with claim 1, wherein graphical navigation icon blocks in each layer are displayed as content rows.

6. A method in accordance with claim 1, wherein graphical navigation icon blocks in each layer are displayed as content columns.

7. A method, comprising:
displaying an initial navigation layer of graphical navigation icon blocks in a fixed focus area on a screen;
displaying a first subsequent navigation layer after a navigation icon from the initial layer has been selected; and
displaying the initial navigation layer as a stack in said first subsequent navigation layer while said first subsequent navigation layer is displayed.

8. A method in accordance with claim 7, further including displaying a second subsequent navigation layer after a navigation icon from the first subsequent navigation layer has been selected and displaying the initial navigation layer and the first subsequent navigation layer as a stack in said second subsequent navigation layer while said second subsequent navigation layer is displayed.

9. A method in accordance with claim 8, wherein navigation layers are accessible through selection of a corresponding stacked graphical navigation icon block.

10. A method in accordance with claim 8, wherein navigation layers represented as stacked graphical navigation icon blocks in the visible stack are hierarchically related.

11. A method in accordance with claim 8, wherein navigation layers represented as stacked graphical navigation icon blocks in the visible stack are hierarchically independent.

12. An apparatus comprising:
a display device;
an input device; and
a processor configured to cause the display device to
display an initial navigation layer in a fixed focus area on a screen, the initial navigation layer including a plurality of graphical navigation icon blocks; and
display a stacked graphical navigation icon block representative of the initial layer and graphical navigation icon blocks representative of subsequent navigation layers as a visible stack in a fixed focus area on the screen after a graphical navigation icon block from the initial layer has been selected such that a followed path is visible.

13. An apparatus in accordance with claim 12, wherein navigation layers are accessible through selection of a corresponding stacked graphical navigation icon block.

14. An apparatus in accordance with claim 13, wherein navigation layers represented as stacked graphical navigation icon blocks in the visible stack are hierarchically related.

15. An apparatus in accordance with claim 13, wherein navigation layers represented as stacked graphical navigation icon blocks in the visible stack are hierarchically independent.

16. An apparatus in accordance with claim 12, wherein graphical navigation icon blocks in each layer are displayed as content rows.

17. An apparatus in accordance with claim 12, wherein graphical navigation icon blocks in each layer are displayed as content columns.

18. An apparatus in accordance with claim 12, further comprising an Internet Protocol television engine, wherein the navigations layers implement television-related control icons.

19. A program product stored on one or more computer readable devices, the program product including:
code executable to cause a display device to display an initial navigation layer in a fixed focus area on a screen, the initial navigation layer including a plurality of graphical navigation icon blocks; and
code executable to cause a display device to display a stacked graphical navigation icon block representative of the initial layer and graphical navigation icon blocks representative of subsequent navigation layers as a visible stack in a fixed focus area on the screen after a graphical navigation icon block from the initial layer has been selected such that a followed path is visible.

20. The program product of claim 19, wherein navigation layers are accessible through selection of a corresponding stacked graphical navigation icon block.

21. The program product in accordance with claim 20, wherein navigation layers represented as stacked graphical navigation icon blocks in the visible stack are hierarchically related.

22. The program product in accordance with claim 20, wherein navigation layers represented as stacked graphical navigation icon blocks in the visible stack are hierarchically independent.

23. The program product in accordance with claim 19, wherein graphical navigation icon blocks in each layer are displayed as content rows.

24. The program product in accordance with claim 19, wherein graphical navigation icon blocks in each layer are displayed as content columns.
